(19) United States
(12) Patent Application Publication
(10) Pub. No.: US 2008/0037419 A1
(43) Pub. Date: Feb. 14, 2008

(54) SYSTEM FOR IMPROVING IGP CONVERGENCE IN AN APS ENVIRONMENT BY USING MULTI-HOP ADJACENCY

(75) Inventors: Sina Mirtorabi, Santa Clara, CA (US); Abhay Roy, Santa Clara, CA (US); Mukhtiar Ahmed Shaikh, San Jose, CA (US); Yousuf Z. Hasan, Mountain View, CA (US)

Correspondence Address: SIERRA PATENT GROUP, LTD., 1663 Hwy 395, Suite 201, Minden, NV, 89423, US

(73) Assignee: CISCO TECHNOLOGY, INC., San Jose, CA (US)

(21) Appl. No.: 11/463,999

(22) Filed: Aug. 11, 2006

(51) Int. Cl. H04J 3/14; H04L 12/56

(52) U.S. Cl. 370/228; 370/401

(57) ABSTRACT

A system for switching from a working path to a protected path when the working path becomes inoperable. In accordance with this system, point to multi-point adjacency is established between interfaces on two directly connected routing systems. This improves the speed at which the switch may occur.

### FIELD OF THIS INVENTION

This invention relates to routing systems. More particularly, this invention relates to switching between paths used to transmit data between a first and a second routing system. Still more particularly, this invention relates to improving convergence in Automatic Protected Switching (APS) between the first and second routing system when a working path becomes inoperable.

### PRIOR ART

In many digital networks, routing systems transmitting the data over the network have dedicated paths for transmitting between two systems. In these networks, the routing systems often have a primary path and a secondary path for transmitting data between two directly connected routing systems. One particular type of network that has multiple direct connections between routing systems is a Synchronous Optical Network (SONET) in which multiple channels may directly connect two routing systems. In a SONET network, APS may be used to ensure that there is a dedicated path for transmitting data between two directly connected routers. In APS, there is a working path for transmitting the data and a protected path which is a dedicated path that is reserved for use to transmit data between the systems in the event that the working path becomes inoperable for some reason.

In a network using APS, it is a problem that when the working path fails, it takes time to establish adjacency over a protected path for transmitting data between the systems. In the time needed to switch to the dedicated path, packets of data may be lost as they are transmitted over the inoperable working path. This is unacceptable for certain types of data such as voice or streaming video in which the loss of data degrades the performance of the end user applications that use the data. Therefore, there is a need in the art for a method for improving convergence and minimizing packet loss when the working path switches to the protected path.

### BRIEF DESCRIPTION OF THE DRAWINGS

The features and advantages of this invention are described in the following detailed description and are shown in the following drawings:

FIG. 1 illustrating a network of routing systems that perform an exemplary embodiment of this invention;

FIG. 2 illustrating a routing system that switches connections using a preferred exemplary embodiment of a system in accordance with this invention;

FIG. 3 illustrating a flow diagram of a process for detecting an inoperable working path and switching to a protected path in accordance with a preferred exemplary embodiment of the system of this invention; and

FIG. 4 illustrating a flow diagram of a process for switching from a working path to a protected path for transmission of data to the first routing system in accordance with a preferred exemplary embodiment of the system of this invention.

### DETAILED DESCRIPTION

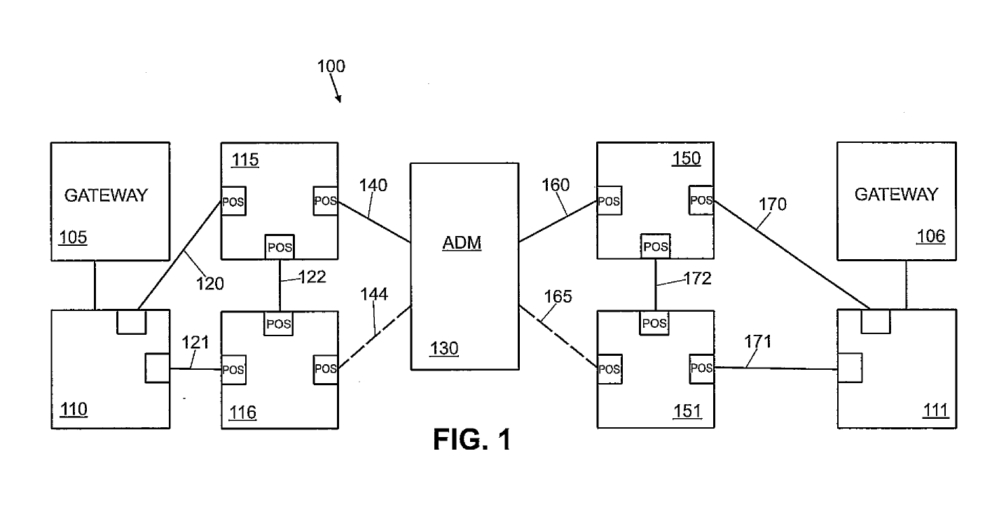

FIG. 1 illustrates an optical network 100 to which the invention may be applied. The network carries data between, for example, device gateways 105 and 106. These gateways are connected to routers 110 and 111, respectively.

Specifically, the router 110 is connected to a router 115 by a primary optical link 120 and to a router 116 by a secondary optical link 121. The router 115 is connected to an add/drop multiplexer (ADM) 130 by an optical fiber working link 140 and the router 116 is connected to the ADM 130 by a fiber backup link 114. A link 142 interconnects the routers 115 and 116.

Similarly, at the other end the ADM 130 is connected to routers 150 and 151 by a working link 160 and a backup link 165, respectively. Routers 150 and 151 are connected to router 111 by a primary link 170 and a secondary link 171. Also a link 172 interconnects the routers 150 and 151. The optical links operate in a full duplex arrangement. Thus each link comprises a pair of optical fibers that carry data in opposite directions. The conversions between the internal electrical structures of the routers and the optical signals carried in the respective fiber links are provided by suitable “POS” units.

OSPF adjacencies are established between the working routers 115 and 150, the routers 115 and 116, and the routers 150 and 151, these routers terminate the optical paths described herein. Thus all of these routers contain identical link state databases from which they derive their routing tables.

In addition to the foregoing conventional arrangement, multi-hop adjacencies are pre-established between the routers 116 and 150, between the routers 115 and 151, and the routers 116 and 151. These latter multi-hop adjacencies are also included in the link state databases, but are assigned higher costs (e.g. maximum cost) than the working adjacencies. By having a pre-established multi-hop adjacency over a protected path, no time is spent in brining up the adjacency when the protected path becomes operational, hence reducing packet loss.

In accordance with the SONET protocol, the routers 115-151 and the ADM 130 frame the data they transmit over the optical links and they deframe the frames they receive over those links.

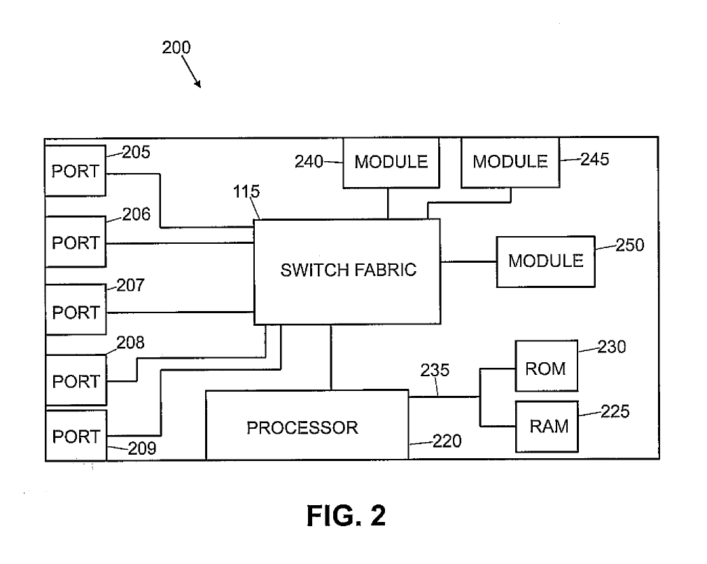

FIG. 2 shows a router 200. Routing systems (Shown in FIG. 1) are all an example of router 200. Router 200 is a switching system that transmits digital data, in the form of packets between processing systems connected to a network. One skilled in the art will recognize that router 200 may be a router, switch or any other processing system that receives and transmits digital data.

Router 200 includes ports 205-209. Ports 205-209 connect router 1200 to other processing systems in a network. The other processing systems that may be connected include computers, other routers or any other digital processing systems. One skilled in the art will further recognize that ports 205-209 are shown for exemplary purposes only and the exact number and configuration of the ports are left to one skilled in the art designing a specific router.

Ports 205-209 are connected to switch circuitry 215. Switch circuitry 215 is circuitry that transmits received packets to the proper ports for delivery to the proper address. One skilled in the art will recognize that there are many different types of circuitry that may be used to transmit packets between proper ports and an explanation of the switching circuitry is not critical to this invention and is omitted for brevity.

Processing unit 220 is connected to switching circuitry 215. Processing unit 220 is a processor, microprocessor, or any combination of processors and microprocessors that execute instructions to perform applications for performing functions in router 200. Processing unit 220 is also connected to a volatile memory 225 and a non-volatile memory 230 via memory bus 235.

Volatile memory 225 is a memory such as a Random Access Memory (RAM). A volatile memory stores instructions and data used by processing unit 220 to perform applications. One such application is a router operating system. The routing operating system is applications which allow router 200 to perform other applications that provide the functions of router 200. An example of a router operating system is Inter-network Operating System (IOS) designed by Cisco Systems Inc. One skilled in the art will recognize that many different types of memory may be used as a non-volatile memory such SRAM and DRAM.

In the preferred exemplary embodiment of this invention, the RAM may also store software application instructions and databases needed to perform the protocols used by network 100. These may include software for maintaining a routing table database and a link state database in a memory in router 200 to perform OSPF.

Non-volatile memory 230 is a memory such as a Read Only Memory (ROM). Non-volatile memory 230 stores configuration and other vital information for router 200. One skilled in the art will recognize that there are many different types of memory that may be used as a non-volatile memory.

Modules 240, 245, and 250 are connected to switching circuitry 215. Modules 240,245, and 250 are device and/or software that prepare specific features in router 200. An example of a module is a Voice over Internet Protocol (VoIP) module for providing telephonic communications to processing devices connected to router 200. One skilled in the art will recognize that the number of modules and the functions each module provides may be determined by one skilled in the art that configures a particular router.

In accordance with this invention, an improved system for switching from a working path to a protected path is provided by processes executed by the routing systems as shown by the following exemplary embodiments. One skilled in the art will recognize that the following processes may be executed by software, firmware, hardware, and/or any combination of the preceding components.

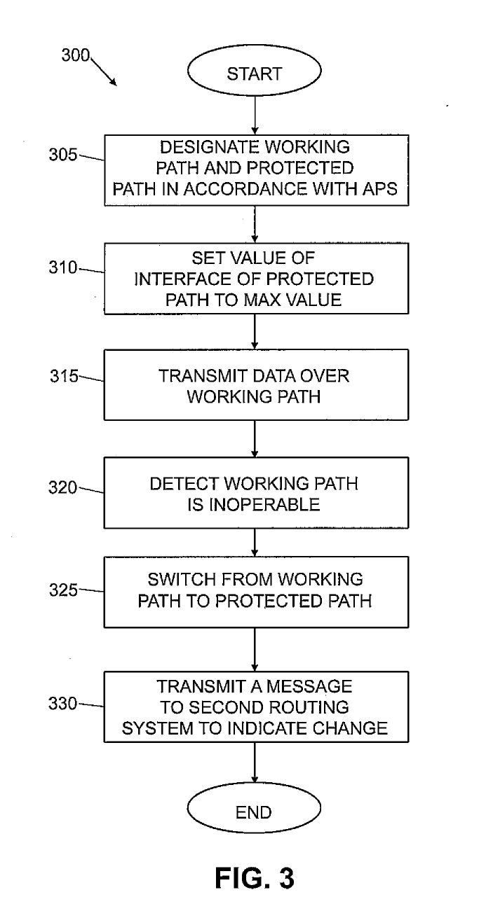

FIG. 3 illustrates an exemplary process 300 executed by a first routing system to detect whether a working path is inoperable and switching to a protected path. Process 300 begins in step 305 with the working and protected path being determined in accordance with the APS protocol. In order to pre-establish a multi-hop adjacency between the routing systems, the OSPF network is configured as point to multi-point so that more than one adjacency could be established over point-to-point POS interface

In step 310, a multi-hop adjacency is established between both routing systems. This is done by sending a unicast control packet to the remote IP address. Note that the protected interface IP address is advertised as /32 stub link due to point-to-multipoint network type and reachable over multi-hop path. The cost of the multi-hop adjacency is set to max value. In a preferred embodiment in which OSPF is used, the value is set to 0xFFFF. This prevents the interface from attracting traffic over a protected path.

In step 315, data is then transmitted between the two routing systems over the direct path. At a later time, the first routing system detects the working path is inoperable in step 320. When this is detected, the cost of the interface connected to the protected path is adjusted to the cost of transmitting over the interface instead of the maximum value in step 325.

After the cost is adjusted, a message is sent to the interface of the second routing system via direct path to indicate the protected path is operational so that the second routing system adjusts the cost accordingly.

In the preferred embodiment, the message is a Hello message with a bit set in the Extended Options (EO) of Link Layer Signals (LLS) of the Hello message. The message signals the interface on the second routing system to advertise adjacency to the interface of the first routing system connected to the protected path with the cost of the interface. After the message is sent the protected path is then the path for transmitting data between the two routing systems and process 300 ends.

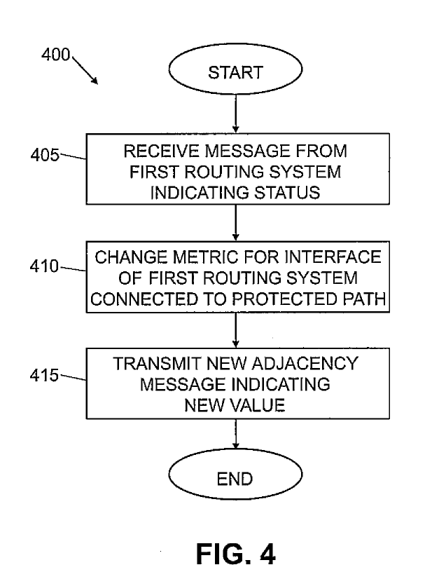

FIG. 4 illustrates an exemplary process 400 executed by a second routing system when a message indicating that the protected path is currently being used to transmit data between the first routing system and second routing system. Process 400 begins in step 405 when a message from the first routing system is received by the second routing system. When, the message is received, the second processing system reads the indication in the message that the interface of the first routing system for the protected path sent the message. In the preferred, exemplary embodiment, a Hello message is received from the interface of the first routing system connected to the protected path. The Hello message includes a set bit in the EO-LLS that indicates the packet was received via the direct path.

In response to receiving the message, the second routing system changes the adjacency from the working path to the protected path in step 410. Afterwards, the second routing system begins advertising adjacency to the interface of the first routing system connected to the protected path with the cost of the protected path interface in step 415 and process 400.

The above are exemplary embodiments for switching from a working path to a protected path in APS in accordance with this invention. It is expected that one skilled in the art can and will design alternative systems that infringe on this invention as set forth in claims below either literally or through the Doctrine of Equivalents.

What is claimed is:

1. A method for switching a connection for transmission of data between a first routing system and a second routing system from a working path to a protected path comprising:
detecting said working path is not operational in a first routing system wherein said working path connects an interface of said first routing system to a interface of a second routing system;
adjusting a path cost in said first routing system to cause transmitted data between said first routing system and said second routing system to be transmitted over said protected path wherein said protected path connects an interface of said first routing system with an interface of said second routing system; and
transmitting a message from said first routing system to said second routing system indicating that said protected path is being used.

2. The method of claim 1 wherein said message is a Hello message.

3. The method of claim 2 wherein said Hello message includes a specified bit that is set to indicate that said working path is to be used.

4. The method of claim 3 wherein said bit is included in a link local signaling section of said Hello message in an extend options section of said link-local signaling.

5. The method of claim 1 wherein said message from said first routing system to said second routing system is transmitted directly between said first and second routing systems responsive to said switching to said protected path.

6. The method of claim 5 further comprising:
transmitting a message from said second routing system indicating said adjusted path cost of said protected path.

7. The method of claim 1 wherein said step of adjusting said path cost comprises:
setting said path cost to a cost of said interface connecting said first routing system to said protected path.

8. The method of claim 1 wherein said working and said protected path are SONET communication channels.

9. The method of claim 8 wherein said first and second routing systems provide Automatic Protection Switching for connections between said first and second routing systems.

10. The method of claim 1 wherein said first and said second routing system use Open Shortest Path First for determining a path for transmitting data to another routing system.

11. The method of claim 1 further comprising:
setting said cost of said protected path to a maximum metric responsive to said working path being operational.

12. An apparatus for switching a connection for transmission of data between a first routing system and a second routing system from a working path to a protected path comprising:
means for detecting said working path is not operational in a first routing system wherein said working path connects an interface of said first routing system to a interface of a second routing system;
means for adjusting a path cost in said first routing system to cause transmitted data between said first routing system and said second routing system to be transmitted over said protected path wherein said protected path connects an interface of said first routing system with an interface of said second routing system; and
means for transmitting a message from said first routing system to said second routing system indicating that said protected path is being used.

13. A system for switching a connection for transmission of data between a first routing system and a second routing system from a working path to a protected path comprising:
circuitry configured to detect said working path is not operational in a first routing system wherein said working path connects an interface of said first routing system to a interface of a second routing system;
circuitry configured to adjust a path cost in said first routing system to cause transmitted data between said first routing system and said second routing system to be transmitted over said protected path wherein said protected path connects an interface of said first routing system with an interface of said second routing system; and
circuitry configured to transmit a message from said first routing system to said second routing system indicating that said protected path is being used.

14. The system of claim 13 wherein said message is a Hello message.

15. The system of claim 13 wherein said Hello message includes a specified bit that is set to indicate that said working path is to be used.

16. The system of claim 15 wherein said bit is included in a link local signaling section of said Hello message in an extend options section of said link-local signaling.

17. The system of claim 13 wherein said message from said first routing system to said second routing system is transmitted directly between said first and second routing systems.

18. The system of claim 17 further comprising:
circuitry configured to transmit a message from said second routing system indicating said adjusted path cost of said protected path.

19. The system of claim 13 wherein said circuitry configured to adjust said path cost comprises:
circuitry in said first routing system for setting said path cost to a cost of said interface connecting said first routing system to said protected path.

20. The system of claim 13 wherein said working and said protected path are SONET communication channels.

21. The system of claim 13 wherein said first and second routing systems provide Automatic Protection Switching for connections between said first and second routing systems.

22. The system of claim 13 wherein said first and said second routing system use Open Shortest Path First for determining a path for transmitting data to another routing system.

23. The system of claim 13 further comprising:
circuitry in said second routing system configured to set said cost of said protected path to a maximum metric responsive to said working path being operational.

24. A computer readable medium carrying one or more instructions executed by a first routing system for switching paths used for transmitting data between said first routing system and a second routing system, the one or more instructions including instructions which are executed by one or more processors, cause the one or more processors to perform the method comprising:
detecting said working path is not operational in a first routing system wherein said working path connects an interface of said first routing system to a interface of a second routing system;
adjusting a path cost in said first routing system to cause transmitted data between said first routing system and said second routing system to be transmitted over said protected path wherein said protected path connects an interface of said first routing system with an interface of said second routing system; and
transmitting a message from said first routing system to said second routing system indicating that said protected path is being used and indicating that said value of said path cost must be adjusted.
